(19) United States
(12) Patent Application Publication
(10) Pub. No.: US 2020/0312315 A1
(43) Pub. Date: Oct. 1, 2020

(54) ACOUSTIC ENVIRONMENT AWARE STREAM SELECTION FOR MULTI-STREAM SPEECH RECOGNITION

(71) Applicant: Apple Inc., Cupertino, CA (US)

(72) Inventors: Feipeng Li, Sunnyvale, CA (US); Mehrez Souden, Los Angeles, CA (US); Joshua D. Atkins, Los Angeles, CA (US); John Bridle, Cheltenham (GB); Charles P. Clark, Mountain View, CA (US); Stephen H. Shum, Walnut Creek, CA (US); Sachin S. Kajarekar, Sunnyvale, CA (US); Haiying Xia, Cupertino, CA (US); Erik Marchi, Cheltenham (GB)

(21) Appl. No.: 16/368,403

(22) Filed: Mar. 28, 2019

(51) Int. Cl. G10L 15/20

(52) U.S. Cl. CPC G10L 15/20

(57) ABSTRACT

An acoustic environment aware method for selecting a high quality audio stream during multi-stream speech recognition. A number of input audio streams are processed to determine if a voice trigger is detected, and if so a voice trigger score is calculated for each stream. An acoustic environment measurement is also calculated for each audio stream. The trigger score and acoustic environment measurement are combined for each audio stream, to select as a preferred audio stream the audio stream with the highest combined score. The preferred audio stream is output to an automatic speech recognizer. Other aspects are also described and claimed.

### FIELD

An aspect of the disclosure here relates to a system for selecting a high quality audio stream for multichannel speech recognition. Other aspects are also described.

### BACKGROUND

Many consumer electronics devices have voice-driven capabilities, such as the ability to act as or interface with a “personal virtual assistant,” by utilizing multiple sound pick up channels in the form of two or more microphones. A key technique to the success of this type of human-machine interaction is far-field speech recognition because the user is typically at some distance from the device that the user is interacting with. However, the microphones may produce mixed audio signals, which contain sounds from various or diverse sources in the acoustic environment (e.g., two or more talkers in the room and ambient background noise). Also, when a talker in a room is sufficiently far away from the microphones, other types of interference may exist, such as reverberation, directional noise, ambient noise, competing speech, etc. These forms of interference may have a significant impact on the performance of a personal virtual assistant, such as producing false positives or missing commands. A user may expect a device to both accurately and rapidly detect an initial voice trigger phrase so that it can respond with reduced latency.

### SUMMARY

An aspect of the disclosure is directed toward a system for achieving high performance speech recognition for a multi-stream speech recognition system. A speech enabled device may include several microphones, e.g., forming a microphone array, that can pick up speech of a talker. A speech recognition capability may be activated by a voice trigger, such as a predetermined trigger phrase. The system may include a multichannel digital signal processor that processes the microphone array signals into a beamforming audio stream and a blind source separation audio stream. A speech processor performs tests for the presence of and the quality of a voice trigger on the audio streams, in order to determine whether there is a preferred stream for speech analysis. This may improve the performance of general speech analysis that is performed downstream upon the preferred stream, including trigger phrase detection, automatic speech recognition, and speaker (talker) identification or verification, by integrating information relating to the acoustic environment of each audio stream with a voice trigger score for each audio stream, and the selecting the stream with a highest combined score.

In one aspect, the audio stream input is from the microphones of not just one but several speech devices (at least one stream that contains sound pickup from each of the several speech devices.) The audio streams from the several devices are tested for presence and quality of a voice trigger in order to determine whether there is a preferred stream for speech analysis in order to optimize the performance of subsequent general speech analysis. The stream that achieves the highest combined score may be output to for example an automatic speech recognizer.

In an aspect, an acoustic environment characteristic that is measured may be signal to noise ratio (SNR.) The system may use the detected trigger phrase as an anchor when calculating the signal to noise ratio. Due to the large variability in time and frequency exhibited by different speech sounds, estimation of SNR and other acoustic properties usually takes a long integration time for a statistical model of speech and noise to converge. This anchor-based method greatly reduces the speech variability by focusing on the trigger phrase, which makes it possible to reliably estimate the acoustic property within a short duration. The signal to noise ratio may be calculated using, for example, a root mean square method.

A preferred audio stream (“preferred” because it is expected to show greater performance than other streams when processed by subsequent or “downstream” speech recognition) may be output through the following process. A plurality of audio streams are received or generated. Testing for the presence of a voice trigger is performed, and if the voice trigger is present (in any one of the audio streams) then a quality of the voice trigger in each audio stream is tested. The quality of the voice trigger in each audio stream may be determined using a combined score that is calculated based on i) a voice trigger score and ii) an acoustic environment measurement (for that audio stream.) If the combined score is sufficiently high, e.g., highest across all of the audio streams, then that stream is selected as the “preferred” stream (such that its payload, and not those contained in the other audio streams, undergoes speech recognition analysis.)

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 illustrates an exemplary block diagram for a system for audio stream selection for multichannel audio selection from a microphone array.

FIG. 2 illustrates an exemplary block diagram for a system for audio stream selection for multichannel audio selection from multiple devices.

FIG. 3 illustrates an exemplary trigger phrase runtime information analysis for signal to noise calculation.

FIG. 4 illustrates an exemplary block diagram for a system for audio stream selection for multichannel audio selection with speech analysis.

FIG. 5 illustrates an exemplary flowchart for a process for audio stream selection for multichannel audio selection.

### DETAILED DESCRIPTION

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

The present disclosure is related to a digital speech signal processing system for achieving high performance far-field speech recognition. The system may include a speech enabled device which may be a device with digital signal processing-based speech signal processing capabilities that may use several microphones that form a microphone array to pick up speech of a user that is in an ambient environment of the device. The speech signal processing is to process the microphone signals in order to improve the fidelity of (e.g., reduce word error rate by) an automatic speech recognition (ASR) process or a downstream voice trigger detection process (that is subsequently performed upon a selected one of several audio streams derived from the microphone signals.) The downstream voice trigger detection and ASR may be elements of a “virtual assistant,” through which a user may instruct the device to undertake certain actions by speaking to the device. The speech enabled device could be, but is not limited to, a smartphone, smart speaker, computer, home entertainment device, tablet, a car audio or infotainment system, or any electronics device with interactive speech features.

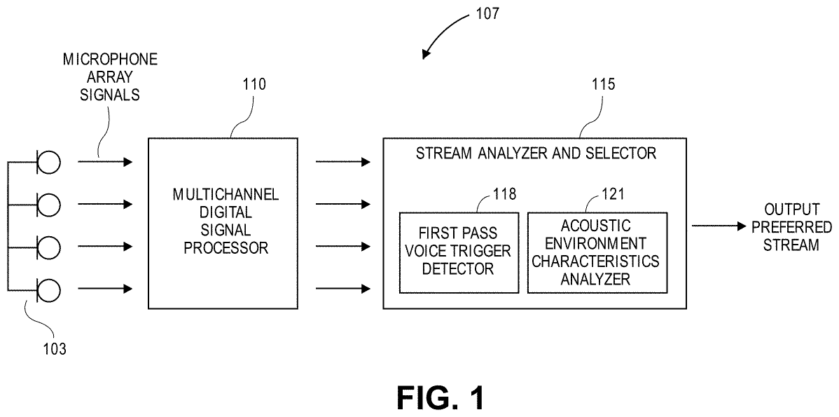

FIG. 1 illustrates a component diagram of a speech system 107 according to one aspect of the present disclosure. The speech system 107 may include a multichannel digital signal processor (DSP) 110 and a stream analyzer and selector (SAS) 115. In an aspect, the speech system 107 may include a memory unit (not shown) that stores instructions that when executed by a digital microelectronic processor cause the components of the speech system 107 shown in FIG. 1 to perform any of the actions discussed herein. The electronic hardware components of the speech system 107 may be entirely located within a housing of the speech enabled device, or parts of them may be located remotely from the device (and may be accessible to the local components for example over the Internet through a wired or wireless connection.

The multichannel DSP 110 and SAS 115 are generically used here to refer to any suitable combination of programmable data processing components and data storage that conduct the operations needed to implement the various functions and operations of the speech system 107. The multichannel DSP and SAS may be implemented as a system on a chip typically found in a smart phone. The memory unit may be microelectronic, non-volatile random access memory. While the multichannel DSP 110 and the SAS are shown as separate blocks in FIG. 1, the tasks attributed to the multichannel DSP 110 and the SAS 115 may be undertaken by a single processor or by multiple processors. An operating system may be stored in the memory unit along with one or more application programs specific to the various functions of the speech system 107, which are to be run or executed by a processor to perform the various functions of the speech system.

The multichannel DSP 110 may receive a plurality of microphone signals from the microphone array 103. The multichannel DSP 110 may process the plurality of microphone array signals into a plurality of audio streams using a beamforming output mode and a blind source separation (BSS) output mode to generate a single beamformed audio stream and a BSS audio stream, respectively. The BSS audio stream could include a plurality of BSS audio streams, wherein one of the BSS audio streams from the plurality of BSS audio streams may contain target speech from a user. In an aspect, the multichannel DSP 110 may use beamforming techniques applied to the plurality of microphone array signals to generate a plurality of beamformed audio streams that are extracted using respective beams steered in different “look directions.”

The audio streams may be transmitted to the SAS 115. The SAS 115 may conduct fitness tests on the audio streams to determine if there is a preferred audio stream available for speech recognition, including a first pass voice trigger detector 118 and an acoustic environment characteristics analyzer 121. The first pass voice trigger detector 118 determines through signal analysis whether any of the audio streams contain a voice trigger (e.g., likely contain a voice trigger), such as a desired trigger phrase that indicates that a user is addressing the device. In an aspect, the first pass voice trigger detector 118 may utilize a deep neural network to convert the acoustic patterns present in the audio streams into a probability distribution over speech sounds, which then outputs as a voice trigger score by using a temporal integration process, wherein the voice trigger score represents the confidence level of a match between an acoustic pattern present in the audio stream and the trigger phrase.

The acoustic environment characteristics analyzer 121 may calculate estimates of acoustic environment measurements for each of the audio streams. Acoustic environment measurements may include, for example, target signal to background noise ratio (signal to noise ratio, SNR), direct to reverberant ratio (DRR), audio signal level, and direction of arrival of the voice trigger. The estimates of the acoustic environment measurements may be adapted to the environment and calculated “live,” or during run time, as the user is talking.

The SAS115 uses a combination of the voice trigger score and the acoustic environment measurements to determine a preferred audio stream (select one of the input audio streams.) For example, the SAS may calculate a stream score (SC) for each input audio stream by adding a voice trigger score (TS) that is multiplied by a voice trigger score weight (W1) and an acoustic environment measurement (AEM), which may include a measurement for a single acoustic environment characteristic or a composite value based on several acoustic environment characteristics, that is multiplied with an acoustic environment measurement weight (W2), such that SC=W1*TS+W2*AEM. The audio stream that has the highest stream score SC is then selected as the preferred audio stream.

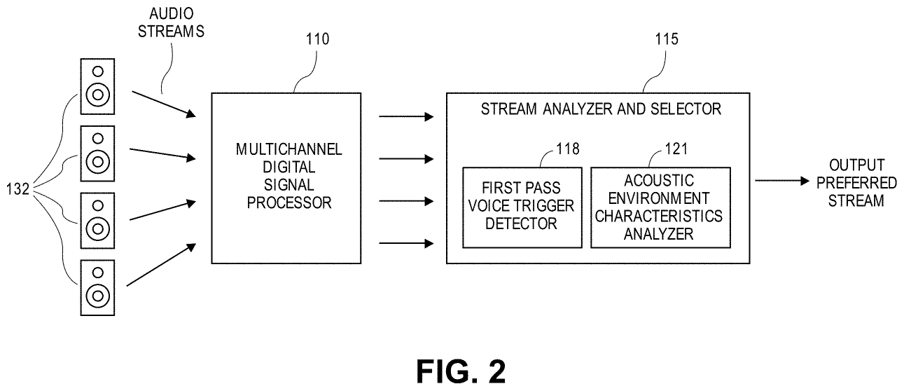

FIG. 2 illustrates an aspect where the speech system 107 receives a plurality of audio streams from a plurality of speech enabled devices 132 that may each include a microphone (i.e., one or more microphones in the housing of each speech enabled device 132.) The process flow described above in connection with FIG. 1 may also be applied here, except that the beamforming and blind source selection modes of the multichannel DSP 110 are optional. As in FIG. 1 though, the SAS 115 may determine an acoustic environment measurement using the acoustic environment characteristics analyzer 121 and a voice trigger score using the first pass voice trigger detector 118 for each audio stream in order to calculate a combined score. The audio stream with the highest combined score may be selected as the preferred audio stream, and the preferred audio stream may be output. In another aspect, the multichannel DSP 110 may process the plurality of audio streams received from the plurality of devices using a beamforming output mode and a blind source separation (BSS) output mode to generate a beamforming audio stream and a BSS audio stream, respectively, as described above in connection with FIG. 1, that are transmitted to the SAS 115.

In an aspect, the preferred audio stream may be selected by separately evaluating the voice trigger score and the acoustic environment measurements. For example, the SAS 115 may determine whether a beamformed audio stream is preferred, by determining based on the acoustic environment characteristics whether the environment is quiet. In contrast, blind source separation audio stream is preferred, by determining based on the acoustic environment characteristics whether the environment is noisy. If the environment is determined to be noisy, then this indicates the desirability of a blind source separation audio stream (rather than a beamformed audio stream). In that case, the SAS may determine which blind source separation audio stream out of a plurality of blind source separation audio streams is preferred by selecting the blind source separation audio stream with the highest voice trigger score to be the preferred audio stream.

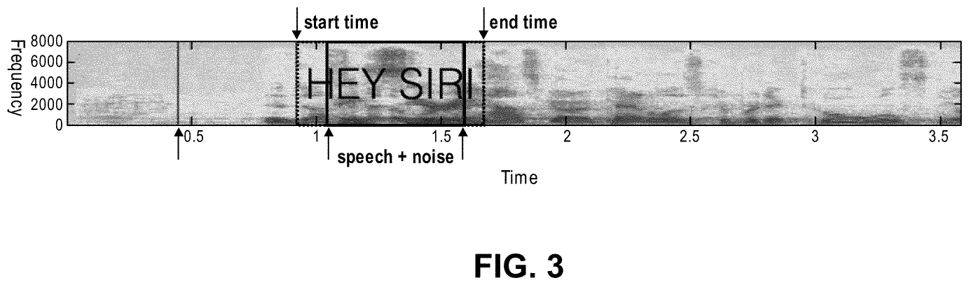

The first pass voice trigger detector 118 may also determine “runtime” information of the voice trigger, as shown in FIG. 3 with the exemplary voice trigger “hey Siri.” The runtime information may be derived from the audio samples between a start time of the voice trigger and an end time of the voice trigger (within a given audio stream.) The first pass voice trigger detector may output the runtime information (e.g., as a portion of the audio stream in the time interval between the start time and the end time) to the acoustic environment characteristics analyzer. The acoustic environment characteristics analyzer 121 may use the runtime information to calculate the acoustic environment characteristics of the output signal. For example, the acoustic environment characteristics analyzer may use the detected voice trigger (e.g., the audio stream from start time to end time) as an “anchor,” such that the acoustic environment characteristics analyzer does not have to account for speech variability across unknown words during analysis. That is because the trigger phrase is, in principle, substantially composed of known speech. Since the acoustic properties of known speech may be reliably estimated (e.g., more reliably than estimating acoustic properties based on unknown speech), the target signal characteristics that are indicative of the quality of the target (speech) signal may be extracted during the runtime of the voice trigger. These desired signal characteristics may include direction of arrival, target speech energy, and direct to reverberant ratio. Further, the start time of the voice trigger may be used as a separation point for calculating “signal” and “noise,” where noise and interference is calculated (from the given audio stream) at a point prior in time to the start time of the voice trigger and “signal” is calculated only between the start time and the end time. This signal and noise are then used to calculate SNR. In another example, SNR may be calculated from the root mean square (RMS) of a portion of the audio stream during the runtime interval (e.g., between the start time and the end time) and a portion of the audio stream before the start time.

In an aspect where the acoustic environment measurement is the SNR, a scoring rule may be determined that produces a combined score from the voice trigger score and SNR for each audio stream, for selecting the preferred audio stream. For a beamformed audio stream, the combined score may be calculated as follows: combined score=voice trigger score+alpha*SNR+beta, wherein alpha and beta are tuning parameters that may be tuned based on data for the device. For each BSS audio stream, the combined score may be calculated as follows: combined score=voice trigger score. The audio stream with the highest combined score may then be selected as the preferred audio stream. Other scoring rules may be considered for determining the preferred audio stream. For example, deep learning may be utilized to devise a data-driven combination rule which automatically selects the preferred audio stream given an SNR and voice trigger score. In another example where the acoustic environment measure is the direction of arrival, the direction information may be utilized to determine a preferred audio stream by comparing the direction of arrival of sound before the start time of the voice trigger to the direction of arrival of sound computed during the runtime interval (the interval from start time to end time.) Audio streams for which the direction arrival of sound prior to the voice trigger is similar to the direction of arrival of sound during the runtime are more likely to contain interference.

In an aspect, the SAS 115 may also include a speaker (talker) identifier. The speaker identifier may use pattern recognition techniques to determine through audio signal analysis whether the voice biometric characteristics of the trigger phrase matches the voice biometric characteristics of a desired talker. If the first pass voice trigger detector 118 has determined with sufficient confidence that an audio stream contains a trigger phrase, the speaker identifier may analyze the audio stream to determine whether the speaker of the trigger phrase is a desired speaker. If the speaker identifier determines that the voice biometric characteristics of the speaker of the trigger phrase matches the voice biometric characteristics of the desired speaker, the SAS may output the audio stream as the preferred audio stream. If the speaker identifier determines that the voice biometric characteristics of the speaker of the trigger phrase does not match the voice biometric characteristics of the desired speaker, the SAS may continue monitoring the audio streams until there is a match.

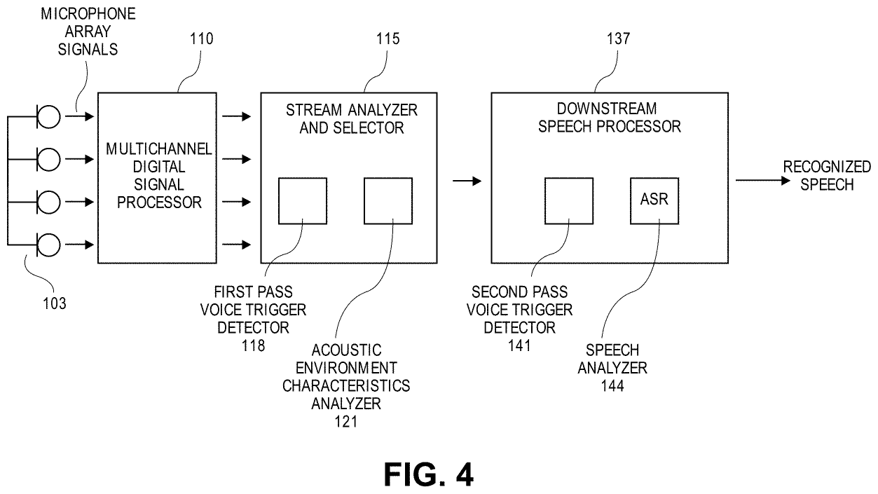

FIG. 4 shows an aspect where the SAS 115 may output the preferred stream to a downstream speech processor 137. The downstream speech processor 137 may include a second pass voice trigger detector 141 and a speech analyzer 144 (e.g., an automatic speech recognizer, ASR.) The second pass voice trigger detector 141 may confirm whether the preferred audio stream contains a voice trigger. If so, then the speech analyzer 144 is given the preferred audio stream to recognize the contents of the payload therein, wherein the payload is speech that occurs after the end time of the voice trigger. The recognized speech output may then be evaluated by a virtual assistant program against known commands and then the device may execute a recognized command contained within the content.

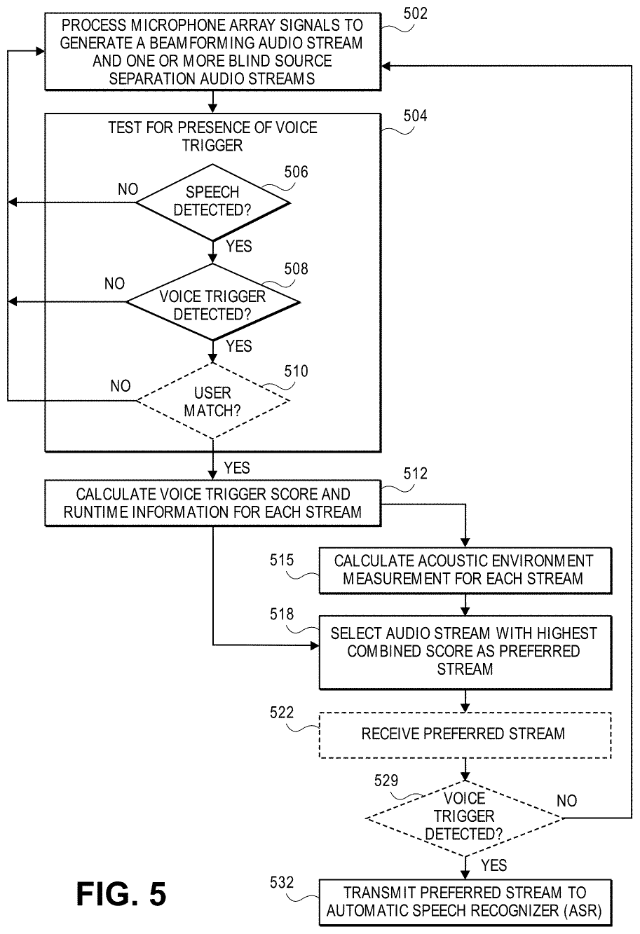

FIG. 5 shows an exemplary flow diagram for digital speech signal processing that selects a preferred audio stream derived from multichannel sound pick up, for downstream voice trigger detection and ASR. At block 502, a processor (e.g., multichannel digital signal processor 110 of FIG. 1) processes the microphone signals from a microphone array to generate a plurality of audio streams, such as a beamformed audio steam and one or more blind source separation audio streams. In one variation, the processor may receive a plurality of audio streams from a plurality of speech enabled devices, respectively, in which case the processing in block 502 that produces a beamformed signal or a BSS signal from microphone array signals is optional, e.g., not needed. At block 504, the processor determines if there is at least one of the plurality of streams that may be used for speech processing. The processor may make this determination by testing the audio streams for the presence of speech containing a voice trigger. If speech is not detected on at least one of the audio streams, then no further action is taken (and the monitoring of the microphone array signals in blocks 502-504 continues) until an audio stream with speech is detected. If speech is detected at block 506, the processor tests the speech to determine if the speech includes a voice trigger at block 508. If the speech does not include a voice trigger, then no further action is taken (and the monitoring mentioned above continues) until an audio stream containing a voice trigger is detected.

Optionally, at block 508, it may be desirable to determine if the detected voice trigger is spoken by a specific user. If the speaker (talker) of the voice trigger does not match any known user's voice, or it does not match that of a specific user, then no further action is taken (and the monitoring mentioned above continues) until an audio stream containing a voice trigger that matches that spoken by a desired user is detected. If there is a match, then the process continues with block 512.

If the presence of a voice trigger has been determined (regardless of any user match in block 510), then at block 512 a voice trigger score and runtime information (e.g., a start time of the voice trigger and an end time of the voice trigger within a given audio stream) may be calculated for each audio stream of the plurality of audio streams.

Acoustic environment measurements may be calculated for each audio stream of the plurality of audio streams at block 515. The acoustic environment measurements calculations may involve data from the runtime information. At block 518, an audio stream is selected as an output, preferred audio stream. The selection may be based on a combined score calculated for each audio stream of the plurality of audio streams using a combination of the acoustic environment measurements and voice trigger score. The audio stream with the highest combined score may be selected as the preferred audio stream.

Optionally, at block 522, a downstream speech processor may test the preferred audio stream in order to confirm the detected voice trigger. If the voice trigger is not confirmed with a sufficient confidence level, then no further action is taken until an audio stream containing a voice trigger is detected. If the voice trigger is confirmed with a sufficient confidence level, then the preferred stream may be provided to the input of an automatic speech recognizer at block 532.

As described above, one aspect of the present technology is the gathering and use of data available from various sources to improve the accuracy of automatic speech recognition. The present disclosure contemplates that in some instances, this gathered data may include personal information data that uniquely identifies or can be used to contact or locate a specific person. Such personal information data can include demographic data, location-based data, telephone numbers, email addresses, TWITTER ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to increase the ability to recognize a specific user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user recognition, the present technology can be configured to allow users to select to “opt in” or “opt out” of participation in the collection of personal information data during registration for services or anytime thereafter. In another example, users can select for voice triggers to be deactivated in certain situations, such as when a sensitive conversation is occurring. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, speech enabled actions may be undertaken without advanced speech content analysis based on non-personal information data or a bare minimum amount of personal information, such as the content being requested by the device associated with a user, other non-personal information available to the speech processor, or publicly available information.

While certain aspects have been described and shown in the accompanying drawings, it is to be understood that such are merely illustrative of and not restrictive on the broad invention, and that the invention is not limited to the specific constructions and arrangements shown and described, since various other modifications may occur to those of ordinary skill in the art. For example, while FIG. 2 depicts a device in which a multichannel DSP receives four audio streams from four devices, respectively, it is also possible to have more or less than four devices, or for another component to process the audio streams between the audio devices and the multichannel DSP, or that one or more of the audio devices provides more than one audio stream. The description is thus to be regarded as illustrative instead of limiting.

What is claimed is:

1. An acoustic environment aware method for selecting a high quality audio stream during multi-stream speech recognition, comprising:
receiving by a processor a plurality of audio streams;
determining whether at least one audio stream of the audio streams includes a voice trigger;
in response to determining that the at least one audio stream includes a voice trigger, for each audio stream of the plurality of audio streams:
generating a voice trigger score associated with the audio stream;
calculating an acoustic environment measurement associated with the audio stream; and
calculating a combined score based on the voice trigger score associated with the audio stream and the acoustic environment measurement associated with the audio stream; and
outputting a preferred audio stream of the plurality of audio streams having the highest combined score.

2. The method of claim 1, wherein the plurality of audio streams include an at least one beamformed audio stream and an at least one blind source separation audio stream.

3. The method of claim 2, wherein the at least one beamformed audio stream and the at least one blind source separation audio stream are generated by processing signals from a microphone array.

4. The method of claim 2, wherein the blind source separation audio stream comprises a plurality of blind source separation audio streams at least one of which contains target speech from a user.

5. The method of claim 1, wherein the plurality of audio streams are received from more than one speech enabled device.

6. The method of claim 1, further comprising:
determining whether a voice trigger is present in the preferred audio stream; and
in response to determining that the voice trigger is present, transmitting the preferred audio stream for speech recognition analysis.

7. The method of claim 1, wherein the acoustic environment measurement comprises at least one of a signal to noise ratio, a direct to reverberant ratio, an audio signal level, or a direction of arrival of the voice trigger.

8. The method of claim 7 wherein determining the voice trigger comprises a determined start time and a determined end time of the voice trigger, and wherein the acoustic environment measurement comprises the signal to noise ratio calculated using i) signal in an interval between the determined start time and the determined end time and ii) noise in an interval before the determined start time.

9. The method of claim 1, further comprising determining whether the voice trigger was spoken by a desired speaker.

10. An acoustic environment aware method for selecting a high quality audio stream during multi-stream speech recognition, comprising:
receiving, by a first pass voice trigger detector, a plurality of audio streams;
determining, by the first pass voice trigger detector, whether at least one of the audio streams includes a voice trigger;
in response to determining that at least one of the audio streams includes a determined voice trigger:
generating a voice trigger score;
calculating a signal to noise ratio by utilizing the determined voice trigger as an anchor;
for each audio stream of the plurality of audio streams, calculating a combined score based on the voice trigger score associated with the audio stream and the signal to noise ratio associated with the audio stream; and
selecting an audio stream with the highest combined score; and
outputting the selected audio stream.

11. The method of claim 10, wherein utilizing the determined voice trigger as an anchor comprises determining a runtime interval that comprises a start time for the determined voice trigger and an end time for the determined voice trigger, and calculating the signal to noise ratio comprises comparing interference or noise during the runtime interval to the interference or noise prior to the start time of the determined voice trigger.

12. The method of claim 11, wherein calculating the signal to noise ratio comprises the root mean square of i) a portion of the audio stream during the runtime interval and ii) a portion of the audio stream before the start time.

13. The method of claim 10, further comprising:
determining in a second pass whether a voice trigger is present on the selected stream; and
in response to determining in the second pass that the voice trigger is present, transmitting the selected audio stream for speech recognition analysis.

14. The method of claim 10, wherein the selected audio stream includes a payload, wherein the payload is speech that comes after the voice trigger.

15. An acoustic environment aware system for selecting a high quality audio stream during multi-stream speech recognition, comprising:
a processor; and
memory having stored therein instructions that when executed by the processor
receive a plurality of audio streams;
determine whether at least one of the audio streams includes a voice trigger;
in response to determining that the at least one of the audio streams includes a voice trigger, for each audio stream of the plurality of audio streams:
generate a voice trigger score associated with the audio stream;
calculate an acoustic environment measurement associated with the audio stream; and
calculate a combined score based on the voice trigger score associated with the audio stream and the acoustic environment measurement associated with the audio stream; and
output a preferred audio stream of the plurality of audio streams having the highest combined score.

16. The system of claim 15, wherein the plurality of audio streams include an at least one beam former audio stream and an at least one blind source separation audio stream.

17. The system of claim 16, wherein the blind source separation audio stream comprises a plurality of blind source separation audio streams wherein at least one blind source separation audio stream contains target speech from a user.

18. The system of claim 16, wherein the at least one beam former audio stream and the at least one blind source separation audio stream are generated by a processor that receives a plurality of audio streams from a microphone array.

19. The system of claim 15, wherein the plurality of audio streams are received from a plurality of speech enabled devices, respectively.

20. The system of claim 15, wherein the processor
determines in a second pass whether a voice trigger is present in the preferred audio stream; and
in response to determining in the second pass that the voice trigger is present, transmits the preferred audio stream for speech recognition analysis.

21. The system of claim 15, wherein the acoustic environment measurement comprises at least one of a signal to noise ratio, a direct to reverberant ratio, an audio signal level, and a direction of arrival of the voice trigger.

22. An acoustic environment aware system for selecting a high quality audio stream during multi-stream speech recognition, comprising:
a processor; and
memory having stored therein instructions that when executed by the processor
receives, by a first pass voice trigger detector, a plurality of audio streams;
determines by the first pass voice trigger detector whether at least one of the audio streams includes a voice trigger;
in response to determining that at least one of the audio streams includes a voice trigger:
generates a voice trigger score for each audio stream of the plurality of audio streams;
calculates a signal to noise ratio for each audio stream by utilizing the voice trigger for the audio stream as an anchor;
for each audio stream of the plurality of audio streams, calculates a combined score based on the voice trigger score associated with the audio stream and the signal to noise ration associated with the audio stream; and
selects as a preferred audio stream the audio stream of the plurality of audio streams that has the highest combined score; and
outputs the preferred audio stream.

23. The system of claim 22 wherein the processor again determines whether a voice trigger is present on the preferred audio stream and in response to again determining that the voice trigger is present, outputs the preferred audio stream for speech recognition analysis.
